(19) United States
(12) Patent Application Publication
(10) Pub. No.: US 2006/0180607 A1
(43) Pub. Date: Aug. 17, 2006

(54) Closure

(75) Inventors: Marcus Guzmann, Muehlhausen (DE); Chris Efstathios Housmekerides, Ludwigshafen (DE); Ralf Wiedemann, Ludwigshafen (DE); Karl-Ludwig Gibis, Ludwigshafen (DE)

Correspondence Address: NORRIS, MCLAUGHLIN & MARCUS, 875 THIRD AVE, 18TH FLOOR, NEW YORK, NY, 10022, US

(73) Assignee: Reckitt Benckiser N.V., Hoofddorp (NL)

(21) Appl. No.: 10/564,117

(22) PCT Filed: Jul. 9, 2004
(86) PCT No.: PCT/GB04/02986

§ 371 Date: Jan. 10, 2006

(30) Foreign Application Priority Data
Jul. 12, 2003 (GB) 0316413.4

(51) Int. Cl. B67D 5/08; B65D 39/00; B32B 27/08; B65D 55/00

(52) U.S. Cl. 222/54; 215/233; 215/6; 220/201; 428/35.7

(57) ABSTRACT

The invention relates to a closure for a bottle. The closure is dispersible in a washing medium, wherein the closure comprises a first component and a second component. Each component defines a seal enclosing a volume within the bottle. The dispersion of each component is activated by a different means.

The present invention relates to a closure, particularly to a multi-component closure suitable for use in a bottle for placement in a washing machine such as a dishwasher.

Closures for bottles and other containers are well known. Typical closures may comprise a screw cap, a cork or a crimped cap. These closures are conventionally removed (manually or with the aid of a tool such as a bottle opener) so that the contents of the bottle or container may be accessed.

A further class of closures are those which seal a bottle or container and which are not removed before use, but instead are removed in the medium in which the contents of the container are to be dispensed. This type of closure has been found to be of benefit where the contents of the container are potentially harmful to a user, thus the contents are kept separate from the user and only allowed to be released in the medium of use. In this way the closure can be used to ensure the contents are released at the correct point in time in the medium.

In order to form such a closure the closure material requires several properties.

Firstly the closure has to be resilient enough to provide a seal until the contents are required by a user. As the contents of containers sold for domestic use typically comprise aqueous based compositions the selection of suitable closure materials is usually limited to those materials which have a low solubility in water.

Additionally the closure has to be able to be dispersed in the medium in which the contents are required. As the contents of containers sold for domestic use are typically sold for use in a domestic washing/dishwasher machine the material has been selected such that it may be dispersed at the usual temperature of operation of such machines (around 30-80° C.).

These factors together with cost considerations have previously dictated that wax has been used as the closure material: wax is insoluble in water and has an appropriate melting point. An example of a container having such a closure is a machine cleaner for placing within a dishwashing machine comprising a bottle having a wax closure.

However, the use of such closures encounters difficulties.

The major difficulty is premature dispersion/disruption of the closure. This is a common occurrence in countries which have warm climates: often the ambient temperate can equal and sometimes exceed the operating temperature of the device in which the closure is to be dispersed. In these countries the heat dispersible closures can suffer premature deterioration before their deployment.

In order to address this problem an additional sealing means is applied. The additional sealing means typically comprises a coating layer of an insoluble layer, such as an insoluble plastic. The plastic layer has to be removed before the container is deployed.

Clearly where such an additional sealing means is used the usefulness of the closure is questionable: any advantages that the heat dispersible closure give to the package are largely negated.

It is an object of the present application to obviate/mitigate the disadvantages outlined above.

According to a first aspect of the present invention there is provided a closure for a bottle, the closure being dispersible in an aqueous medium, the closure comprising a first and a second component, each component defining a seal enclosing a volume within the bottle, wherein the dispersion of each component is activated by a different means.

We have found that closures in accordance with the present invention have excellent properties, especially when compared with closures of the prior art. The closure has been found to be particularly effective when exposed to unfavourable storage conditions. Since the closure has two separate components, the dispersion of which is triggered by a different mechanism, then only one of the components would be detrimentally effected by exposure to, for example, an elevated temperature. In such a case then at least one of the components remains coherent and provides an effective seal.

The closure provides a more reliable sealant for a bottle as it has two individual components acting together. This provides greater security for bottles which contain substances which could be detrimental to a consumer if brought into contact with a consumer.

In this document where the term bottle is used it is understood that any container which has a dispersing aperture is intended. A bottle, recognised to comprise a vessel having a neck which terminates in a dispensing aperture, is a preferred example of such a container and is used for convenience throughout this document.

Generally the first component of the closure is insoluble in water.

It is preferred that dispersion of the first component of the closure is triggered by an elevated temperature. Namely, the first component may melt/be caused to melt by exposure to an elevated temperature.

The elevated temperature is preferably between 30° C.-90° C., more preferably between 40° C.-80° C., and most preferably about 50° C.

Generally the first component of the closure comprises a wax. Preferred examples of waxes include paraffin waxes. Paraffin waxes generally comprise long chain saturated hydrocarbon compounds. Preferred hydrocarbon compounds are linear or branched compounds and comprise from 12 to 70 carbon atoms.

Alternatively the first component of the closure may comprise a fat or a solidified surfactant.

It is preferred that dispersion of the second component of the closure is triggered by contact with an aqueous medium.

Preferably dispersion of the second component of the closure is triggered/caused by exposure to an aqueous environment. Namely, the second component may disperse/be caused to disperse by exposure to an aqueous environment.

Preferably the second component comprises a water soluble polymer.

Generally the water soluble polymer comprises polyvinyl alcohol, polylactic acid, polyvinyl pyrrolidone, polyethyleneglycol or a mixture thereof. Most preferably the polymer comprises polyvinyl alcohol.

The composition of the second component may be selected such that dispersion is not brought about unless the aqueous environment has certain specific conditions. For example, the component may be selected such that it has no or only a limited solubility at a pH-value above 10 and at a pH-value below 9 has an adequate solubility. This would be particularly useful where the closure is for use in an automatic dishwasher and it is desired to maintain the integrity of the second component of closure in washing liquor of the dishwasher in the early washing cycles (which typically have a pH of 10 or more) yet as the pH of the washing liquor decreases, such as in the clear rinsing cycle, the second component becomes substantially dissolved.

In this case the second component preferably incorporates a polymer and in particularly preferred manner a pH-sensitive polymer, which has at least one repeat unit, which has at least one basic function, which is not part of the polymer backbone chain.

Preferably the polymer has at least one repeat unit based on a compound selected from the group comprising vinyl alcohol derivatives, acrylates or alkyl acrylates, having said basic function.

Most preferably the polymer is a carbohydrate functionalized with said basic function.

The basic function is preferably an amine, preferably a secondary or tertiary amine.

Alternatively the repeat unit is based on a compound with the 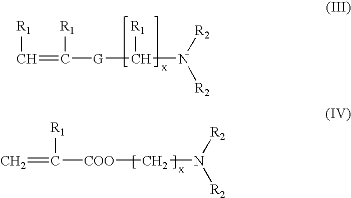
following formula III:
in which G is a linking group chosen from —COO—, —OCO—, —CONH—, —NHCO—, —NHCONH—, —NHCOO—, —OCONH— or —OCOO—, R₁ independently of one another is hydrogen or an alkyl group with 1 to 3 carbon atoms, R₂, independently of one another, hydrogen or an alkyl group with 1 to 5 carbon atoms and x an integer from 1 to 6.

The repeat unit is preferably based on a compound with the following formula IV:

in which R₁, independently of one another, is hydrogen or an alkyl group with 1 to 3 carbon atoms, R₂, independently of one another, hydrogen or an alkyl group with 1 to 5 carbon atoms and x an integer from 1 to 6.

In a further alternative the basic function is an imine or a basic aromatic N-containing group, preferably a pyridine group or an imidazole group.

In a yet further alternative the pH-sensitive polymer is derived from chitosan.

Generally the closure is arranged such that the second component of the closure is uppermost (closest to the opening of the dispensing aperture of the bottle).

In accordance with a second aspect of the present invention there is provided a bottle for use in a washing machine, the bottle comprising a two component closure dispersible in an aqueous medium, each component defining a seal enclosing a volume within the bottle, wherein the dispersion of each component is activated by a different means.

It will be understood that the features of the first aspect of the invention shall apply mutates mutandis to the second aspect of the invention.

It is preferred that at least one component of the closure is intended to be disposed within or adjacent to a dispensing aperture of a bottle.

The components of the closure may be arranged in a layered structure, e.g. as a two layer structure.

The layers may be arranged such that they abut against one another. In this arrangement the synergistic mutual supporting relationship of the two layers is strongest.

In this regard the applicants were surprised not only to observe this effect but also that the manufacture of such a bi-layer structure was possible. It had been expected that since the two layers have quite different physical properties that manufacture/maintenance of the structural integrity of such a bi-layer structure would not be possible. Namely as one layer is dispersed by contact with an aqueous medium, i.e. is typically hydrophilic, and the other layer is dispersed not by contact with an aqueous medium but instead by elevated temperature conditions, i.e. is typically hydrophobic, it would be expected that the two layers would be mutually incompatible and repulse one another. This theory has been surprisingly proved to be incorrect.

Alternatively the layers may be distanced from one another. In this case it will be appreciated that as each layer forms a seal, enclosing a volume of the bottle, two separate volumes of the bottle may be sealed by the closure components. Namely an upper volume may be sealed in a volume defined by the two components of the closure and internal surfaces of the bottle therebetween and a lower volume may be sealed between the lower layer of the closure and the lower internal surfaces of the bottle. This latter arrangement may be particularly suitable for a two component composition: the closure may be used to seal the composition within a container with each of the components of the composition being sealed separately from one another. This is particularly advantageous where the composition components have a low compatibility and need to be kept separate before use e.g., wherein a first component composition comprises an acid and a second component composition comprises an enzyme or wherein a first component composition comprises an acid and a second component composition comprises a base or wherein a first composition comprises a bleach and a second composition comprises an enzyme.

The latter arrangement may also be useful where a delayed release of a component of the contained composition is required. The layers may be disposed such that as a first activation trigger is reached the upper component of the closure is dispersed releasing the contents of the upper volume. The contents of the lower volume are thus retained until the second activation trigger is reached when the lower component of the closure is dispersed releasing the contents of the lower volume.

In a further embodiment the bottle may comprise two compartments. Each compartment may be sealed by a different component of the closure. It will be appreciated that in this arrangement a delayed release function may also be achieved.

Preferably the two compartments are formed by a division extending from adjacent a dispensing aperture of the bottle to an inner surface on the bottle. Most preferably the division extends from adjacent the dispensing aperture to a base of the bottle.

Preferably the bottle contains a detergent composition. Preferred examples of detergent compositions include a machine cleaning composition; separated two component composition including an enzyme comprising composition and an acid comprising composition; separated two component composition including an enzyme comprising composition a bleach/oxidising agent comprising composition.

Generally the bottle is for use in a domestic washing machine. Preferred examples of such machines include automatic dishwashing machines and automatic laundry machines.

The bottle may have an additional sealing means. Preferably the additional sealing means comprises a screw cap. The screw cap, where present, is preferably attached to the bottle in co-operation with an appropriate thread.

The invention is further illustrated in the following Figures, wherein: —

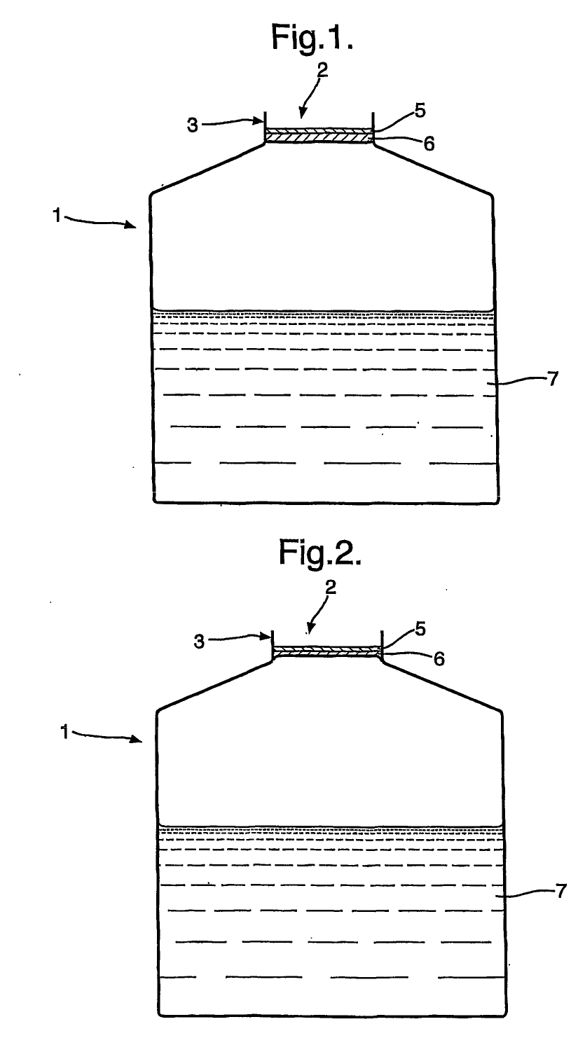

FIG. 1 is a cross-sectional view of a bottle having a layered closure disposed within the neck of the bottle;

FIG. 2 is a cross-sectional view of the bottle of FIG. 1, wherein the bottle has been exposed to an excessive storage temperature;

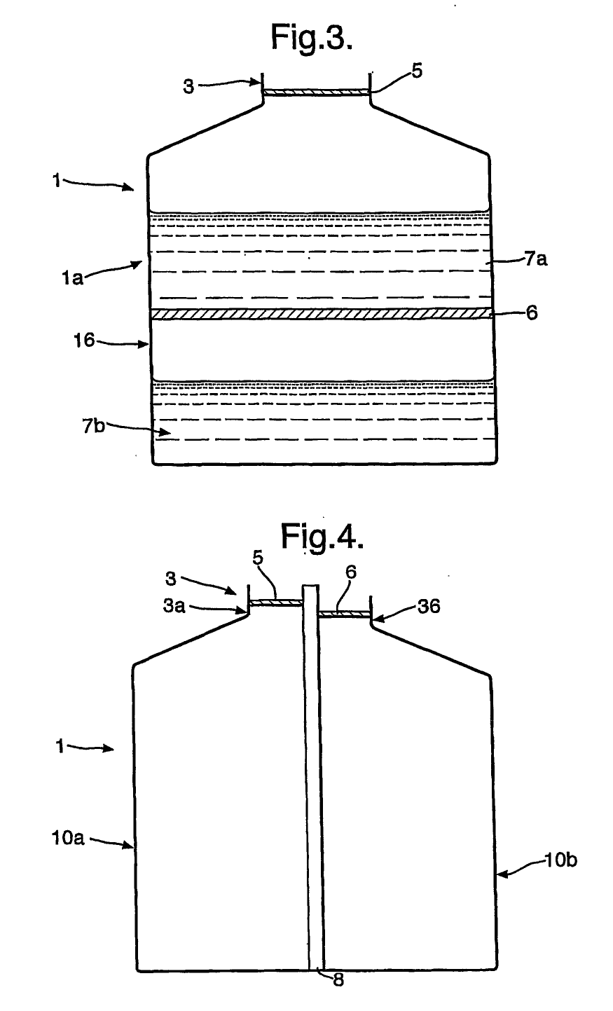

FIG. 3 is a cross-sectional view of a bottle as in FIG. 1, with the closure having an alternate arrangement within the bottle; and

FIG. 4 is a cross-sectional view of a two-compartment bottle having a layered closure disposed within the neck of the bottle.

FIG. 1 illustrates a bottle 1 having a closure 2 in accordance with the present invention. The bottle 1 has a neck 3, within which is disposed the closure 2.

The closure 2 comprises two layers 5, 6. Each layer forms a coherent seal across the neck of the neck 3 of the bottle 1. The layers 5,6 abut against one another. The uppermost layer 5 is preferably a water soluble polymer such as polyvinyl alcohol (PVOH). The lowermost layer 6 is preferably a water insoluble wax, such as paraffin wax.

In use the closure 2 of the bottle 1 is exposed to an aqueous medium such as the washing liquor of an automatic dishwashing machine (not shown). The uppermost layer 5, by virtue of its solubility in water, is dispersed and becomes solubilised in the aqueous medium, thus exposing the lowermost layer 6. The lowermost layer 6 remains intact until the temperature of the aqueous medium is high enough to initiate the melting of the lowermost layer 6. When this occurs the contents 7 of the bottle 1 are the exposed to the aqueous medium and may be released from the bottle 1.

Before use (e.g. in storage) the arrangement of the layers 5 and 6 is such that they have a synergistic relationship: each layer aids the stability of the other.

A benefit of this synergistic relationship is shown with reference to FIG. 2. Here the bottle 1 of FIG. 1 is illustrated, wherein the bottle 1 has been briefly exposed to an excessive storage temperature (i.e. a temperature above that of the melting point of layer 6). It can be seen that the excessive temperature has caused some melting of the layer 6 with the effect that some of the material of layer 6 has run down the neck 3 of the bottle 1. Thus overall the thickness of layer 6 has been reduced.

However, due to the presence of the upper layer 5 a significant amount of the material which comprises layer 6 has been retained in position, enough to constitute a coherent layer 6. Whereas in the absence of layer 5 the integrity of later 6 would have been wholly lost. Clearly, the presence of layer 6, albeit in a reduced thickness ensures that the release of the bottle contents in use is prevented until the aqueous medium has reached a sufficient temperature to melt layer 6.

FIG. 3 illustrates an alternative arrangement of the closure compared to that shown in FIG. 1. In this embodiment the layers 5, 6 of the closure 1 are separated. This has the effect of dividing the bottle 1 into an upper portion 1a in the volume between the layers 5 and 6 and a lower portion 1b in the volume beneath the layer 6 and the base of the bottle 1. The reader will appreciate that the relative sizes of the portions 1a and 1b may differ from those shown in FIG. 3.

In this embodiment the bottle contents 7 are divided into two portions; a first portion 7a (disposed in bottle portion 1a) and a second portion 7b (disposed in bottle potion 1b). It will be appreciated that the water content/availability of portion 7a is low such that layer 5 is not detrimentally affected before use.

In use on exposure to an aqueous medium the first portion 7a is released as the layer 5 becomes dispersed. The second portion 7b is retained in the bottle 1 until the temperature of the aqueous medium is sufficient to melt the layer 6.

This embodiment finds particular use where the portions 7a and 7b are mutually incompatible. For example the portion 7a may contain an enzyme and the portion 7b may contain a bleach. These two components are recognised to be mutually incompatible (especially in the presence of water) as typically the bleach causes inactivation of the enzyme.

In FIG. 4 the bottle 1 is divided by a wall 8 which extends from the base of the bottle 1 up to the neck 3 of the bottle 1. The wall 8 divides the bottle 1 into two separate portions 10a and 10b, each having its own neck (which serves as a dispensing aperture) 3a and 3b respectively. The neck 3a is sealed by layer 5 and the neck 3b is sealed by layer 6.

In use on exposure to an aqueous medium the first portion 10a is released as the layer 5 becomes dispersed. The second portion 10b is retained in the bottle 1 until the temperature of the aqueous medium is sufficient to melt the layer 6.

This embodiment also finds particular use where the contents of portions 10a and 10b are mutually incompatible.

1. A closure for a bottle, the closure being dispersible in a aqueous medium, the closure comprising a first component and a second component, each component defining a seal enclosing a volume within the bottle, wherein the dispersion of each component is activated by a different means.

2. A closure according to claim 1, wherein the first component of the closure is insoluble in water.

3. A closure according to claim 1 wherein the dispersion of the first component of the closure is triggered by an elevated temperature mechanism.

4. A closure according to claim 3, wherein the elevated temperature is between 30° C.-90° C.

5. A closure according to claim 1, wherein the first component of the closure comprises a wax.

6. (canceled)

7. A closure according to claim 1, wherein the dispersion of the second component of the closure is triggered by contact with an aqueous medium.

8. (canceled)

9. A closure according to claim 7 wherein the second component comprises a water soluble polymer.

10. A closure according to claim 9, wherein the water soluble polymer comprises a polymer selected from polyvinyl alcohol, polylactic acid, polyvinyl pyrrolidone or a mixture thereof.

11. (canceled)

12. A closure according to claim 7, wherein the second component of the closure has no or only a limited solubility at a pH-value above 10 and, at a pH-value below 9, has a solubility such that it becomes dissolved.

13. A closure according to claim 12, wherein the component comprises a pH-sensitive polymer incorporating a repeat unit having a basic function, separate from the backbone chain of the polymer.

14. A closure according to claim 13, wherein the repeat unit is based on a compound selected from the group consisting of vinyl alcohol derivatives, acrylates and alkyl acrylates having said basic function.

15. A closure according to claim 13, wherein the polymer is a carbohydrate functionalised with the basic function.

16. A closure according to claim 13 wherein the basic function is an amine.

17. A closure according to claim 16, in which the repeat unit is based on a compound of formula III: 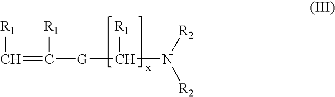
in which G is a linking group selected from —COO—, —OCO—, —CONH—, —NHCO—, —NHCONH—, —NHCOO—, —OCONH— or —OCOO—,
each R₁ is, independently, hydrogen or an alkyl group with 1 to 3 carbon atoms,
each R₂ is, independently, hydrogen or an alkyl group with 1 to 5 carbon atoms,
and x is an integer from 1 to 6.

18. A closure according to claim 16, in which the repeat unit is based on a compound of formula IV: 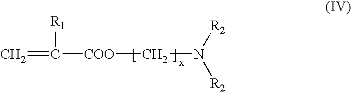
in which R₁ is hydrogen or an alkyl group with 1 to 3 carbon atoms, each R₂ is, independently, hydrogen or alkyl group with 1 to 5 carbon atoms, and x is an integer from 1 to 6.

19. A closure according to claim 1, wherein the components of the closure are arranged in a two layer structure.

20. A closure according to claim 19, wherein the closure is disposed within or adjacent to a dispensing aperture of the bottle.

21. A closure according to claim 19, wherein the layers abut against one another.

22. A closure according to claim 19, wherein a first layer is disposed within or adjacent to a dispensing aperture of the bottle defining a first seal and a second layer is disposed across a lower portion of the bottle defining a second seal.

23. (canceled)

24. A bottle for use in a washing machine, the bottle comprising a two component closure dispersible in an aqueous medium, each component defining a seal enclosing a volume within the bottle, wherein the dispersion of each component is activated by a different means.

25. A bottle comprising a closure according to claim 1.

26. A bottle according to claim 25 wherein the components of the closure are arranged in a two layer structure.

27. A bottle according to claim 26, wherein the closure is disposed within or adjacent to a dispensing aperture of the bottle.

28. (canceled)

29. A bottle according to claim 26, wherein a first layer is disposed within or adjacent to a dispensing aperture of the bottle defining a first seal and a second layer is disposed across a lower portion of the bottle defining a second seal.

30. A bottle according to claim 25, wherein the bottle has two compartments with each compartment being sealed by a different component of the closure.

31. A bottle according to claim 30, wherein the two compartments are formed by a division extending from adjacent a dispensing aperture of the bottle to the base of the bottle.

32. (canceled)

33. A bottle according to claim 25 containing a detergent composition, wherein a portion of the composition is sealed by a first component of the closure and a second potion is sealed by a second portion of the closure.

34. A bottle according to claim 33, wherein the detergent composition is a machine dishwashing detergent composition.

35. (canceled)

36. A bottle according to claim 25, wherein the bottle comprises an additional sealing means.

37. (canceled)
